(19) United States
(12) Patent Application Publication
(10) Pub. No.: US 2005/0195161 A1
(43) Pub. Date: Sep. 8, 2005

(54) Numerical value input device

(76) Inventor: Jun Nagasawa, Chiba-shi (JP)

Correspondence Address: BRUCE L. ADAMS, ESQ.;31ST FLOOR, 50 BROADWAY, NEW YORK, NY, 10004, US

(21) Appl. No.: 11/074,172

(22) Filed: Mar. 7, 2005

(30) Foreign Application Priority Data
Mar. 8, 2004 (JP) 2004-063848

(51) Int. Cl. G09G 5/00

(52) U.S. Cl. 345/156

(57) ABSTRACT

There is provided a user interface capable of effectively inputting a desired numerical value only by using a pointing device such as mouse, without using a keyboard. It possesses a key input area in which the numerical value is input by a keyboard, and a mouse input area which is connected with the key input area and in which a coordinate axis expressing the input range of that key input area has been displayed, and which has been configured so that, if a point on the coordinate axis of the mouse input area is specified by the pointing device such as a mouse, the coordinate value of that specified point is inputted to the key input area.

### BACKGROUND OF THE INVENTION

1. Field of the Invention

The present invention relates to a numerical value input device, and especially relates to a numerical value input device concerning a user interface for inputting a measuring condition and the like in an analysis apparatus.

2. Description of the Related Art

In a recent graphical user interface using a widow system, as seen in JP-A-10-049538 Gazette (FIG. 1), it is adapted so as to perform a character input to an input area on a screen by using a mouse and a keyboard. As a character input area, it is frequent that such a text box as shown in FIG. 9 is used. In the drawing, 14 is a title describing the input content of the text box, and 15 is the text box in which a character is inputted. An input method to the text box 15 is as follows. First, the text box of an input object is clicked by a pointing device such as mouse. Input focus is applied to the text box concerned, and it is emphatically displayed. Subsequently, if key input is performed from the keyboard, the character inputted to the present text box is set. In this way, the conventional text box procedure allows input of the character by using the mouse and the text box in turn.

In the recent input methods, although almost all operations are performed by the mouse, when inputting a character to the text box, the operation must be shifted to the keyboard, which has been troublesome. Especially, when inputting to plural text boxes, the operations must be shifted many times between the mouse and the keyboard, an intricate operation. In software performing data analysis and control of analysis apparatus, the window which inputs parameters of the measuring conditions and an analyzing condition often has 20-30 text boxes, and the input to such a window has been very irksome because of frequent shifting between the mouse and the keyboard.

Further, in preparation work before performing the measurement, it is frequent that, while performing work such as measurement of a sample, an operator inputs measuring conditions to a desktop computer while standing. While standing, it is difficult to perform the input to the keyboard, so that there has been a demand for a device that allows performance of all operations by the mouse as far as possible.

Incidentally, as a method of performing the character input by the mouse, there is a software keyboard. The software keyboard is one in which an image of the keyboard is displayed on a screen, and the input is performed by clicking the key on that keyboard by the mouse. However, in the software keyboard, there is a problem that a mouse operation is troublesome and hard and it is easier to input from the usual keyboard, and it occupies the screen and thus becomes an obstacle, so that it is scarcely used except for a case where the usual keyboard cannot be used.

### SUMMARY OF THE INVENTION

A problem of an input device according to the invention is to provide a user interface capable of effectively inputting a desired numerical value only by the pointing device such as mouse without depending on such a software keyboard as mentioned above.

The numerical value input device in the invention possesses a key input area in which numerical values are inputted by a keyboard, and a mouse input area which is connected with the key input area and in which a coordinate axis expressing an input range of the key input area has been displayed, and has been adapted so as to possess a function by which, if a point on the coordinate axis of the mouse input area is specified by a pointing device such as a mouse, a coordinate value of that specified point is inputted to the key input area.

Because the numerical value input device of the invention has been adapted so as to possess the function of inputting the numerical value by displaying the coordinate axis expressing the input range of the key input area and specifying the coordinate on the coordinate axis by the pointing device such as mouse, since the numerical value input can be effectively performed solely by a pointing device such as mouse and the coordinate value can be specified by specifying one graduation along the coordinate axis, it is possible to simply input a round number, such as 10, 20, 30. Additionally, by the fact that there has been installed a function capable of simply altering the display range of the coordinate axis by a button or mouse operation on the mouse input area, the spacing of the graduations of the coordinate axis can be simply changed to coincide with the desired preciseness of the numerical values to be inputted, so that an accurate numerical value input can be simply performed.

### BRIEF DESCRIPTION OF THE DRAWINGS

FIG. 1 is a diagram showing a numerical value input interface of one embodiment of the invention;

FIG. 2 is a diagram showing a numerical value input method by a click;

FIG. 3 is diagram showing a coordinate range alteration method by a zoom-in button;

FIG. 4 is diagram showing a coordinate range alteration method by a zoom-out button;

FIG. 5 is diagram showing a coordinate range alteration method by dragging;

FIG. 6 is a diagram showing a method of scrolling a coordinate axis;

FIG. 7 is a diagram showing an operation method of a measuring condition input window;

FIG. 8 is a flowchart showing operation of the numerical value input interface of the invention; and

FIG. 9 is a diagram showing a conventional text box.

FIG. 10 is a numerical value input device according to the present invention.

### DETAILED DESCRIPTION OF THE INVENTION

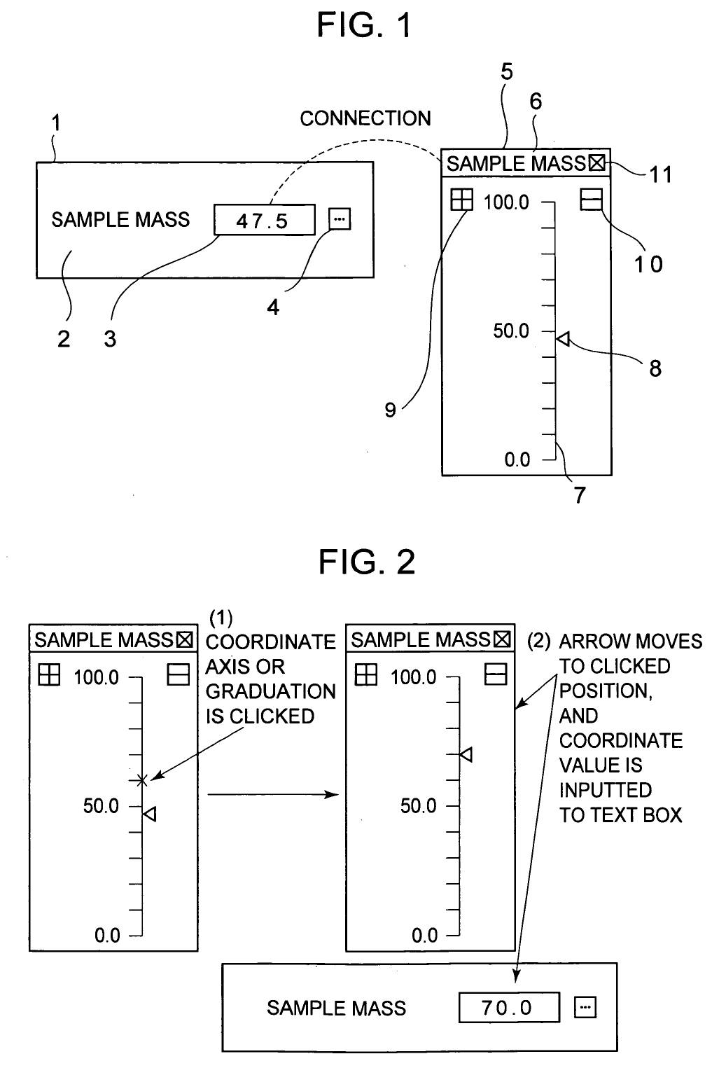

A constitution of a numerical value input interface in the invention is shown in FIG. 1.

In the drawing, 1 is a key input area in which a numerical value is input from a keyboard, and in this area is a title 2 describing the input content of a text box, a text box 3, and a call button 4 for calling a mouse input area 5.

The mouse input area 5 is an area for performing the numerical value input, and related to the key input area 1. A title 6 in mouse input area 5 which is the same as the title 2 is appended to the mouse input area 5 so that the connection is clear. In a case where there are plural key input areas 1, there are prepared plural mouse input areas 5 respectively connected with the key input areas 1. A coordinate axis 7 expresses an input range of the key input area 1, and a coordinate value indicated by an arrow 8 coincides with a numerical value displayed in the text box 3.

Numerical values of the arrow 8 and the text box 3 are linked so that if either one is altered, the other one is also changed.

As shown in FIG. 2, if an operator clicks one point or one of the graduations on the coordinate axis 7 by a mouse, the arrow 8 moves to the clicked position, and its coordinate value is inputted to the text box 3. In a case where it is desired to input a round number such as 10, 20, 30 . . . , it can be simply performed if that graduation is clicked. Further, it is also possible to move the arrow 8 by dragging the mouse.

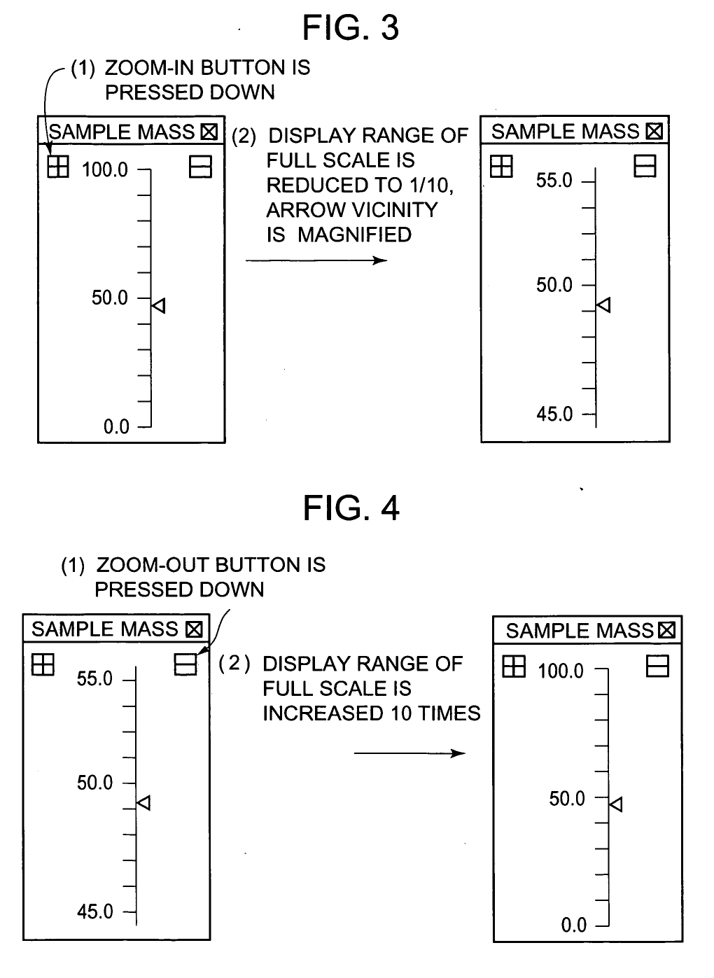

It is possible to alter the display range of the coordinate axis 7 by a zoom-in button 9 and a zoom-out button 10. As shown in FIG. 3, if the zoom-in button 9 is clicked, every time it is clicked the display range of the coordinate axis 7 is reduced by a previously set rate (e.g., 1/10) with the coordinate of the arrow 8 being made the center, and thus it is possible to magnify the vicinity of the arrow 8. As shown in FIG. 4, if the zoom-out button 10 is clicked, every time it is clicked the display range of the coordinate axis 7 is magnified by a previously set rate (e.g., 10 times), and it is possible to display a wider range.

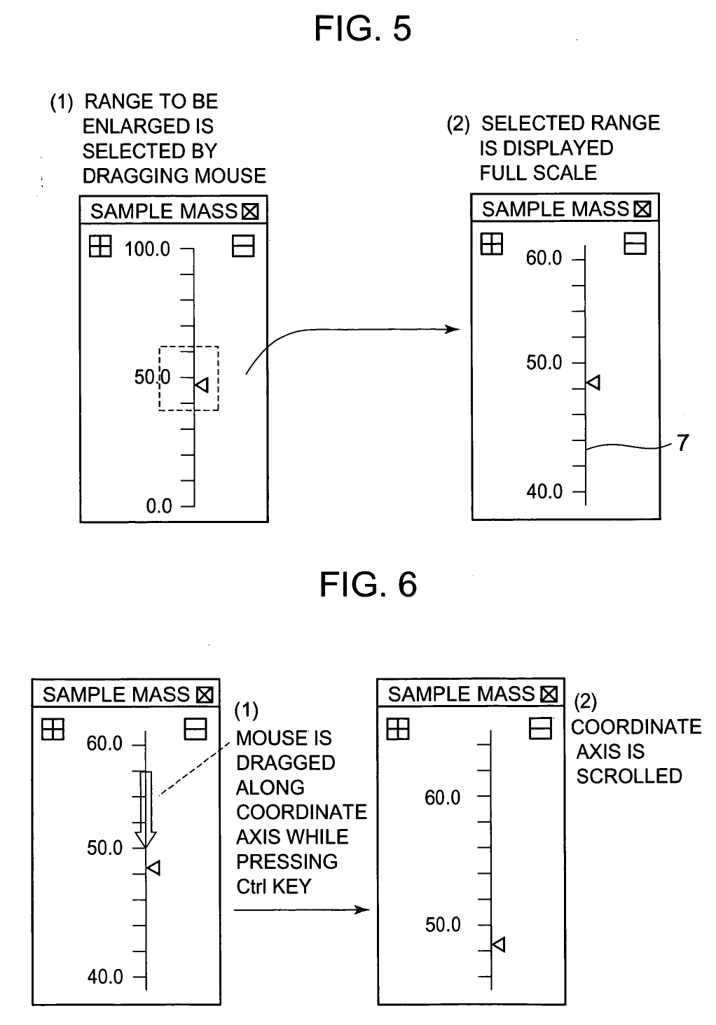

Incidentally, it is also possible to adapt operation such that this zoom-in or zoom-out is performed by an operation of a rotation or drag of a wheel of the mouse. In a case of performing it by the rotation of the wheel, the zoom-in is implemented if the wheel is rotated in one direction, and the zoom-out is implemented if it is rotated in a reverse direction. In the case of performing it by dragging, as shown in FIG. 5, if a rectangular region is selected by being dragged on the coordinate axis 7, the coordinate region contained in that rectangular region is displayed as the full scale.

Further, the coordinate axis 7 possesses a function of scrolling the display range. As shown in FIG. 6, if the mouse is dragged parallel to the coordinate axis 7 while pressing the Ctrl key, the display range of the coordinate axis 7 is moved while retaining the distance from the lowest coordinate value to the highest coordinate value intact. The Ctrl key is pressed to distinguish this mouse action from the click specifying the coordinate position of the arrow 8, and it may be a Shift key or an Alt key instead of the Ctrl key. Further, it is also possible to allocate this scroll operation to another mouse operation such as the rotation of the wheel. That is, it is possible to suitably configure each operation (the zoom-in, the zoom-out and the scroll) altering the display range of the coordinate axis 7 to be a mouse operation such as the drag of the mouse and the rotation of the wheel.

Usually, the mouse input area 5 is not displayed on a screen in order not to unnecessarily occupy the screen. If the input focus is applied to the text box 3 of the key input area 1, the mouse input area 5 connected to the text box is automatically displayed on the screen. Or, if the call button 4 is clicked, it is possible to display the mouse input area 5. The mouse input area 5 continues to be displayed while the operator is performing an input operation to the key input area 1 or the mouse input area 5, in other words, while the input focus is set to either of the key input area 1 or the mouse input area 5, and, if the key input area 1 and the mouse input area both do not have the input focus, the mouse input area 5 automatically is erased from the display. Further, it is also possible to erase the mouse input area from the display at another time by clicking a close button 11 while the mouse input area 5 is being displayed. In this manner, since the mouse input area 5 is erased from the display when input therein is unnecessary and at most only one mouse input area 5 is displayed even in a case where plural text boxes exist on the screen, there is no time when a mouse input area 5 unnecessarily occupies the screen, or when many mouse input areas 5 are simultaneously displayed, causing confusion as to where to make input.

Incidentally, for a case where it is bothersome that the mouse input area 5 is automatically displayed or erased from the display by the change of input focus, it is possible to configure the software so that the operator can select whether to perform automatic display or automatic disappearance according to input focus on a mouse input area 5. In a case where it has been selected that the automatic display or the automatic disappearance according to input focus on a mouse input area 5 is not to be performed, it follows that the display or the disappearance of the mouse input area 5 is performed by the call button 4 or the close button 11.

As described above, the invention is an input device which performs the numerical value input of parameters e.g. of the measuring conditions and the analyzing conditions used by the analysis apparatus, which provides an analysis apparatus capable of effectively and accurately performing the numerical value input only by the pointing device such as a mouse by being configured to possess the function by which a coordinate axis is displayed in a mouse input area connected with a particular key input area and the numerical value is inputted by specifying a coordinate value on the coordinate axis by the pointing device. However, the input device concerning the invention is not limited to an analysis apparatus, and is a technique which can be widely and generally applied to numerical value input work on a computer.

Embodiment 1

Here is shown an example of an analysis apparatus to which the invention has been applied, and its actuation is concretely explained.

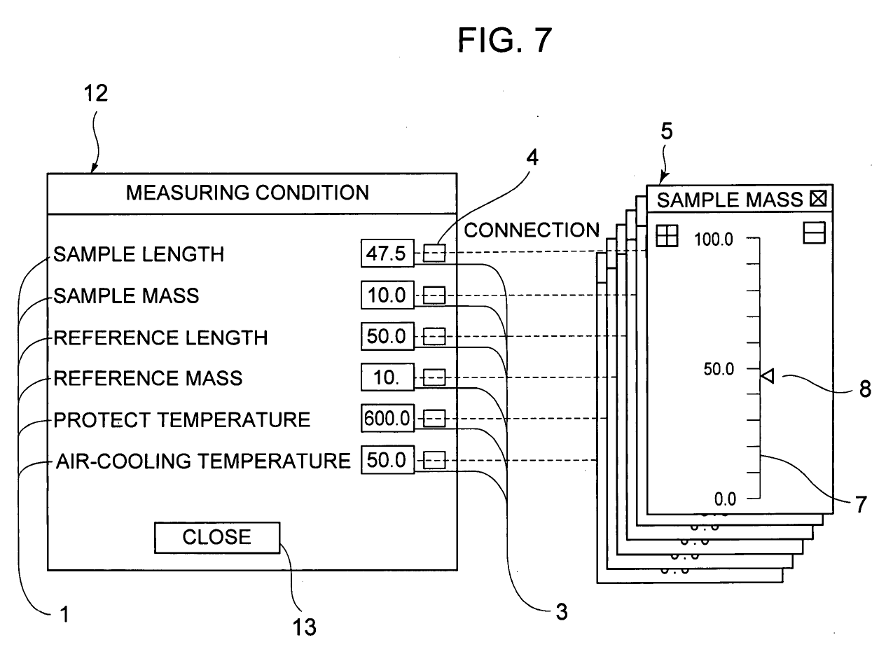

FIG. 7 is a diagram showing a measuring condition input window of the analysis apparatus to which a numerical value input interface of the invention has been installed.

In the drawing, 1 is the key input area for inputting the parameters of the measuring conditions.

The mouse input areas 5 respectively connected with each of the key input areas 1 have been prepared and, at the beginning of operation when a measuring condition input window 12 has been opened, these mouse input areas 5 are not displayed on the screen. If the operator clicks the text box 3 of any of the key input areas 1, the mouse input area 5 connected with that key input area 1 is displayed on the screen. The operator clicks on the coordinate axis 7 of the displayed mouse input area 5, thereby setting the arrow 8 to a desired coordinate value. The coordinate value indicated by the arrow 8 is then input to the text box 3. Incidentally, in a case where the operator wishes to perform the input from the keyboard, it is also possible to perform a keyboard input to the text box 3. If the input to one text box 3 is terminated, the operator clicks the next text box 3. The mouse input area 5 that had been displayed till then is automatically closed, and the mouse input area 5 connected with the text box 3 which has been newly clicked is displayed. If the inputs to the text boxes 3 have been all made, the operator clicks a closing button 13 of the measuring condition input window 12, thereby terminating measuring condition input.

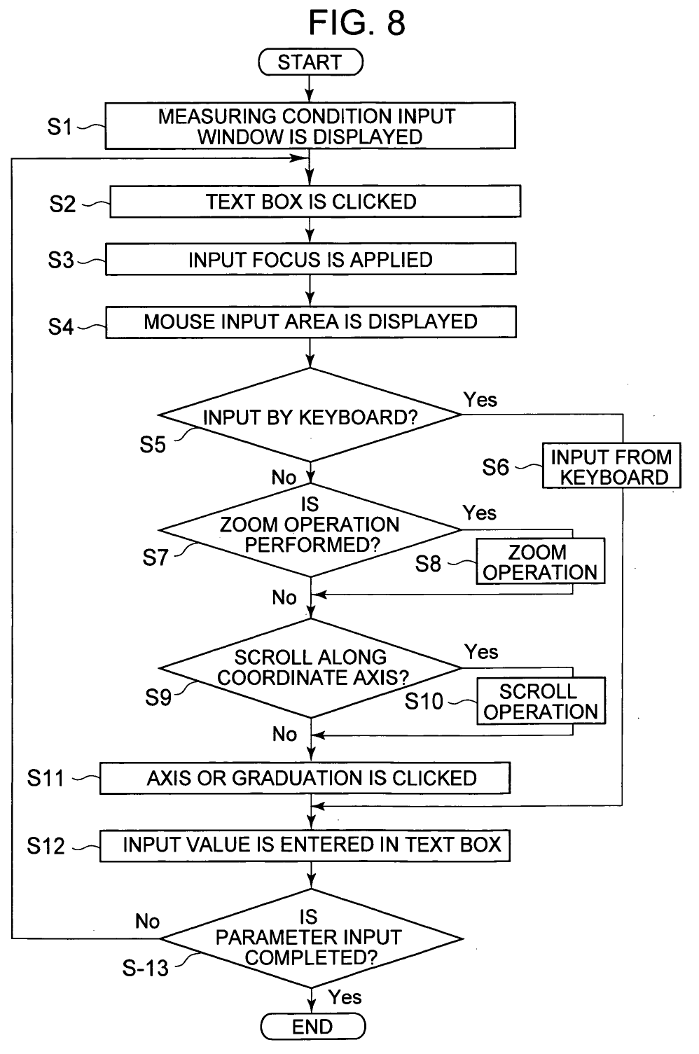

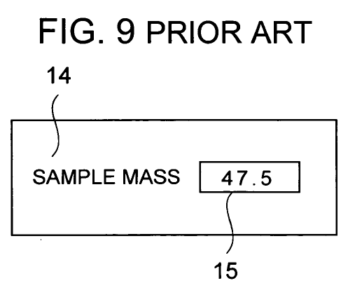

Next, the actuation of the present input device is explained referring to the flowchart shown in FIG. 8.

(S-1) By an execute command from the operator, the measuring condition input window 12 of FIG. 7 is displayed on the screen.

(S-2) The operator clicks, from among the text boxes 3 disposed on the measuring condition input window 12, the one to be given input.

(S-3) The input focus is applied to the clicked text box 3, thereby becoming the input location.

(S-4) The mouse input area 5 connected with the clicked text box 3 is displayed.

(S-5) In the case where the input is performed by the keyboard, the operator inputs the numerical value using the keyboard (S-6). In the case where input is performed by the mouse, operation proceeds to (S-7).

(S-7) The operator confirms whether or not the spacing of the graduations of the coordinate axis 7 is suitable for the value to be inputted. In the case where it is desirable to make more minute the spacing of the graduation, or conversely in the case where it is desirable to make the spacing between the graduations greater, there is performed a zoom operation (S-8) comprising for example pressing a zoom-in or -out button, a drag operation, or mouse wheel operation.

(S-9) The operator confirms whether or not the coordinate value to be inputted is included in the display range of the coordinate axis 7 and, in a case where it is beyond the display range of the coordinate axis 7, the scroll operation such as drag and wheel rotation is performed to the coordinate axis 7, thereby displaying the coordinate value to be inputted (S-10).

(S-11) On the coordinate axis 7, the coordinate value to be inputted is clicked. At this time, if a graduation is clicked, a round number such as 10, 20, or 30 can be simply inputted.

(S-12) The clicked coordinate is entered in the text box 3.

(S-13) Till the inputs of all parameters are completed, the cycle (S-2)-(S-12) is repeated.

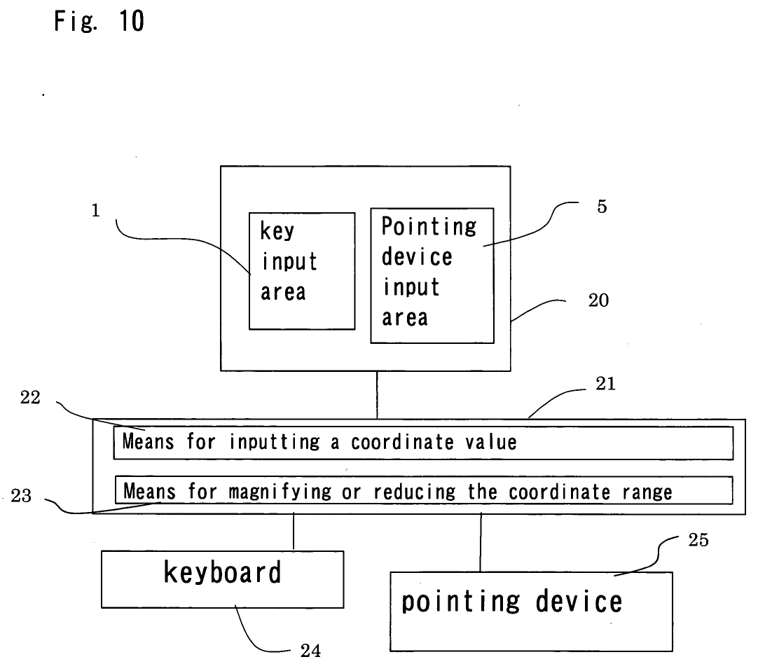

FIG. 10 shows a numerical value input device according to the present invention.

Display 20 has a key input area displaying a numerical value inputted by keyboard 24, and a pointing device input area 5 displaying a coordinate axis related to the key input area and corresponding to the input range of key input area 1. Pointing device input area 5 is an area pointed by pointing device 25. Means 22 for inputting a coordinate value specified on the coordinate axis by pointing device 25 enter the coordinate value to key input area 1. Means 23 magnifies or reduces the coordinate range of the pointing device input area by a predetermined operation of pointing device 25.

1. A numerical value input device comprising:
a keyboard;
a display having a key input area displaying a numerical value inputted by the keyboard, and a pointing device input area displaying a coordinate axis related to the key input area and corresponding to the input range of the key input area, any points of the coordinate axis being pointed by the pointing device; and
means for inputting a coordinate value specified on the coordinate axis by the pointing device to the key input area.

2. A numerical value input device according to claim 1, wherein the pointing device input area is displayed on the display when the key input area related to the pointing device input area has been selected.

3. A numerical value input device according to claim 1, further comprising means for magnifying or reducing the coordinate range of the pointing device input area by an operation of the pointing device.

4. A numerical value input device according to claim 3, wherein the operation of the pointing device which performs the magnification or the reduction of the coordinate range is an operation selecting a region by dragging along the coordinate axis of the pointing device input area.

5. A numerical value input device according to claim 3, wherein the operation of the pointing device, which performs the magnification or the reduction of the coordinate range, is an operation rotating the wheel of the mouse.

6. A numerical value input device according to claim 3, wherein the operation of the pointing device, which performs the magnification or the reduction of the coordinate range, is the clicking of a magnifying or reducing button provided on the pointing device area.
